(19) United States
(12) Patent Application Publication
(10) Pub. No.: US 2019/0373542 A1
(43) Pub. Date: Dec. 5, 2019

(54) METHOD FOR CHANGING CELLULAR COMMUNICATION NETWORK FOR AN OBJECT USING A UICC CHIP CARD, NOT REQUIRING THE CHIP CARD TO BE CHANGED OR REPROGRAMMED

(71) Applicant: TRANSATEL, PUTEAUX (FR)

(72) Inventor: Romain Durand, Paris (FR)

(21) Appl. No.: 16/478,984

(22) PCT Filed: Jan. 18, 2018
(86) PCT No.: PCT/FR2018/050126

§ 371 Date: Jul. 18, 2019

(30) Foreign Application Priority Data
Jan. 19, 2017 (FR) 1750442

(51) Int. Cl. H04W 48/18; H04W 76/10; H04W 48/02; H04W 8/04

(52) U.S. Cl. CPC H04W 48/18; H04W 8/04; H04W 48/02; H04W 76/10

(57) ABSTRACT

The present invention relates to a method for establishing a connection between an object and a first cellular communication network, the object including a UICC chip card and being connected to a second cellular communication network, the UICC chip card storing a list of cellular communication networks that are forbidden for connection, the method comprising the following steps: a step of transmitting, by the object, a request to establish a connection with the second cellular communication network; a step of deleting content from the list of forbidden cellular communication networks; a step of notifying that communication was refused by the second cellular communication network; a step of transmitting, by the object, a request to establish a connection with the first cellular communication network; and a step of establishing the connection between the object and the first cellular communication network.

### RELATED APPLICATIONS

This present application is a National Phase entry of PCT Application No. PCT/FR2018/050126 filed Jan. 18, 2018, which claims priority to French Application No. 1750442 filed Jan. 19, 2017, the contents of each being incorporated herein by reference in their entireties.

### TECHNICAL FIELD

The present invention generally relates to the field of telecommunications, and more specifically to the field of communication between one or more cellular communication network(s) and an object comprising a UICC (Universal Integrated Circuit Card) chip card.

In particular, embodiments of the invention aim for a method for establishing a connection between an object provided with a UICC chip card and a first cellular communication network, when the object is moreover connected to a second cellular communication network and the access from the UICC chip card to this second cellular communication network has just been forbidden within an HLR (Home Location Register) or HSS (Home Subscriber Server) system, without this being limiting in the scope of the present invention, the UICC chip card is for example a SIM (Subscriber Identity Module) card.

### BACKGROUND

In certain cases of use relating to an object provided with a UICC chip card connected to a cellular communication network, it is essential to be able to change network operator without changing UICC chip card. This is typically the case when the UICC chip card is installed indwelling in the object, for example in the case of a UICC chip card welded within a vehicle.

In this context, a first known solution consists of a remote reprogramming of the UICC chip card, by using the connection between the latter and a cellular communication network. In practice, a profile for updating a new network operator is remotely transmitted to the UICC chip card, via the cellular communication network, by a server of this network. Such a remote updating is more commonly called OTA (Over The Air) updating.

However, a disadvantage of such an OTA remote reprogramming solution resides in the lack of reliability thereof. Indeed, such a solution has no limited success rate as if the UICC chip card is not connected to a cellular communication network at the time of the updating, thus the chip card cannot be reached and the network operator change within the latter cannot be made.

Another known solution consists of a method aiming to act at the core of a cellular communication network, more specifically within an HLR (Home Location Register) type system, and consisting of authorizing, within this system, access from the UICC chip card to the cellular communication network operated by the new operator.

However, such a solution leads to a certain number of problems. Indeed, there is a standardized mechanism in UICC chip cards of the connected objects, by which the chip card comprises a memory storing a list of forbidden cellular communication networks for the connection. Yet, prior to the network operator change, the UICC chip card is connected to another cellular communication network than the network operated by the new operator. This means, in practice, that a cellular communication network ID operated by the new operator can be contained in the list of forbidden cellular communication networks. Thus, even after authorization within the HLR type system, the UICC chip card of the object automatically reads this list of forbidden networks and cannot be connected to the cellular communication network operated by the new operator, even after restarting of the object.

A first solution to this problem consists of remotely updating the UICC chip card, via an OTA updating, so as to delete in the list of forbidden networks, the ID of the cellular communication network, operated by the new operator. This first solution however returns to the OTA remote reprogramming solution outlined above, and generates the same disadvantage.

A second solution to this problem consists of the remote transmission to the object of a message intended for a user of the object, such a message indicating to the user to make a manual selection of the cellular communication network operated by the new operator, which makes it possible to furthermore pass the list of forbidden networks.

However, such a manual solution is not very reliable as dependent on the correction execution of the instruction by the user and an effective connection to a cellular communication network. Such a solution is furthermore limiting and not very comfortable for the user of the object.

### SUMMARY

Embodiments of the invention describes below aims to overcome all or some of the disadvantages of the state of the art and in particular to propose a simple and reliable solution making it possible for a network operator change without changing UICC chip card within the object, not requiring reprogramming or remote updating of the UICC chip card, and making it possible for an effective connection with the cellular communication network operated by the new operator.

This aim is achieved thanks to the method for establishing a connection between an object and a first cellular communication network, the object comprising a UICC chip card and communication means over a cellular communication network, connected to the UICC chip card, the object being connected to a second cellular communication network, the UICC chip card comprising a memory storing a list of forbidden cellular communication networks for the connection, the list comprising an ID of the first cellular communication network,
the method comprising the following steps:
   a step of transmitting, by the object over the second cellular communication network, of a request to establish a connection to the second cellular communication network; and
   a step of notifying that communication was refused by the second cellular communication network;
wherein the method further comprises:
   a step of deleting the content of the list of forbidden cellular communication networks;
   a step of transmitting, by the object over the first cellular communication network, of a request to establish a connection to the first cellular communication network; and
   a step of establishing the connection between the object and the first cellular communication network.

Thus, this solution makes it possible to achieve the abovementioned aim. In particular, thanks to the step of deleting the content of the list of forbidden cellular communication networks, a simple and reliable solution, making it possible for an effective network operator change without changing UICC chip card within the object, is obtained. Indeed, via this deletion operation, the ID of the first cellular communication network, operated by the new operator, is in particular deleted from the list of forbidden cellular communication networks. The object can thus be successfully connected to the first cellular communication network, operated by the new operator.

Furthermore, thanks to the method according to embodiments of the invention, no reprogramming or remote updating of the UICC chip card is necessary to carry out the operator change, since the step of deleting the content of the list of forbidden cellular communication networks is used by the UICC chip card itself.

According to a specific technical characteristic of embodiments of the invention, the last cellular communication network to which the object is successfully connected and stored within the UICC chip card.

Advantageously, if the last cellular communication network to which the object is successfully connected is the second cellular communication network, the step of deleting the content of the list of forbidden cellular communication networks is performed after the step of transmitting a request to establish a connection to the second cellular communication network.

This makes it possible to obtain an optimization of the mechanism for deleting the content of the list of forbidden cellular communication networks. The performances of the UICC chip card, and therefore of the object comprising it, are thus improved, in particular in terms of calculation resources available and response time. Typically, the UICC chip card will not proceed with deleting the content of the list of forbidden cellular communication networks periodically and “blindly”, but only when this proves to be appropriate.

According to a specific technical characteristic of embodiments of the invention, if the last cellular communication network to which the object is successfully connected is not the second cellular communication network, but a third cellular communication network, the method further comprises a step aiming to test if the third cellular communication network is associated with the second cellular communication network via a preestablished roaming service, the step of deleting the content of the list of forbidden cellular communication networks being used if the result of the test step is positive.

Advantageously, the method further comprises a step of reading, by the object, the content of the list of forbidden cellular communication networks, the reading step being performed after the deletion step.

This makes it possible for the object to quickly obtain the content updated of the list of forbidden cellular communication networks, in particular when the content of this list is not deleted periodically and “blindly”. The object can thus be connected to the first cellular communication network, as soon as the updating is carried out in the UICC chip card.

According to a specific technical characteristic of embodiments of the invention, the memory of the UICC chip card furthermore stores a list of cellular communication networks to be favored for the connection and/or a list of cellular communication networks equivalent to a domestic cellular communication network, at least one of the lists initially comprising an ID of the second cellular communication network; and the method further comprises a step of deleting the ID of the second cellular communication network within the or one of the list(s), and a step of adding an ID of the first cellular communication network within the or one of the list(s).

This makes it possible for an optimization relating to connection attempts of the object to cellular communication networks of which access is thus forbidden, in the case where the content of the list of forbidden cellular communication networks is deleted periodically and “blindly”. Indeed, the object only attempts to connect to cellular communication networks of which the ID is contained in one or the other of the list of cellular communication networks to be favored or of the list of equivalent cellular communication networks. If access to a cellular communication network is thus forbidden to the object, but that the ID of this cellular communication network has been deleted within the list of forbidden cellular communication networks, the object will not attempt to connect usefully to it. The performances of the object are thus improved, in particular in terms of calculation resources available and response time.

Advantageously, the method further comprises a step of reading, by the object, the content of the list of cellular communication networks to be favored and/or the content of the list of cellular communication networks equivalent to a domestic cellular communication network.

This makes it possible for the object to quickly obtain the content updated of the list of cellular communication networks to be favored and/or of the list of cellular communication networks equivalent to a domestic cellular communication network.

According to another aspect, embodiments of the invention also relate to a computer program product which can be downloaded from a communication network and/or recorded on a support which can be read by UICC chip card type computer and/or which can be executed by a processor, wherein the program product comprises program instructions, the program instructions being adapted to use at least steps of notifying and deleting the method for establishing a connection such as described above when the program product is executed on a processing unit of the object or on the UICC chip card.

According to another aspect, embodiments of the invention also relates to a UICC chip card comprising a memory, wherein the memory stores a computer program product comprising program code instructions to use at least adding and deletion steps of the method for establishing a connection such as described above.

According to a specific technical characteristic of the invention, the UICC chip card is a SIM card.

According to another specific technical characteristic of the invention, the UICC chip card is a SIM card intended to be installed indwelling in an object, the memory of the SIM card storing one single ID.

### BRIEF DESCRIPTION OF THE DRAWINGS

Other characteristics and advantages of the invention will emerge upon reading the following description, given only as an example, and made in reference to:

FIG. 1 is a schematic representation of a communication assembly capable of using the method for establishing a connection according to the invention;

FIG. 2 is a flowchart representing the method for establishing a connection between an object and a cellular communication network, according to the invention, used by the communication assembly of FIG. 1.

### DETAILED DESCRIPTION

Below, it is disclosed, in particular, a method for establishing a connection between an object 12 and a first cellular communication network 14A. As a non-limiting example, the object 12 can be a mobile telephone or also a connected vehicle.

By “firmware”, this means a set of instructions and of data structures which are integrated in the IT hardware such that the latter can function.

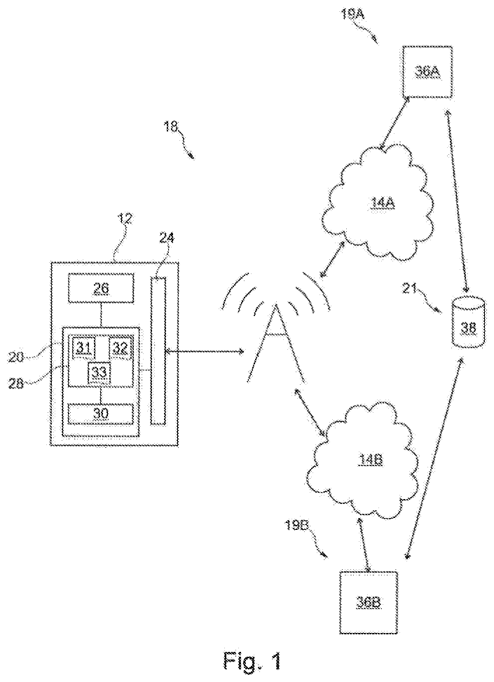

A first cellular communication network 14A and a second cellular communication network 14B are represented schematically in FIG. 1. A communication assembly 18 according to an embodiment of the invention is connected to the first and second cellular communication networks 14A, 14B.

Each cellular communication network 14A, 14B is provided with a private or extended communication infrastructure, making it possible to connect, or access, server and/or database and/or communication device type communication equipment. Conventionally, the communication infrastructure forms a wireless network, or a wired network, or also a network comprising a wireless portion and a wired portion. In a specific embodiment, each cellular communication network 14A, 14B is designed as a GSM (Global System for Mobile Communication) or UMTS (Universal Mobile Telecommunications Systems) type network.

The first and second cellular communication networks 14A, 14B are separate networks.

The communication assembly 18 comprises the object 12, a first communication system 19A and a second communication system 19B. The communication assembly further comprises an HLR (Home Location Register) or HSS (Home Subscriber Server) system 21. The first communication system 19A, respectively the second communication system 19B, is connected to the HLR or HSS system 21 and to the first cellular communication network 14A, respectively to the second cellular communication network 14B. The object 12 is connected to the second cellular communication network 14B. In particular, the object 12 is thus connected to the second communication system 19B.

The object 12 comprises a UICC (Universal Integrated Circuit Card) chip card 20, and communication means 24 over a cellular communication network 14A, 14B. Preferably, the object 12 further comprises calculation means 26, as illustrated in FIG. 1.

The UICC chip card 20 is connected to the communication means 24 over a cellular communication network 14A, 14B, and to the calculation means 26. The UICC chip card 20 comprises a memory 28 and a microprocessor 30 connected to the memory 28. The UICC chip card 20 is, for example, a SIM (Subscriber Identity Module) chip card. The UICC chip card 20 is, for example, a SIM chip card installed indwelling within the object 12, for example by welding. This can, in particular, be the case when the object 12 is a vehicle.

The memory 28 stores an application 31 and a list 32 of forbidden cellular communication networks for the connection. Preferably, as illustrated in FIG. 1, the memory 28 furthermore stores a list 33 of cellular communication networks to be favored for the connection. Also preferably, when the UICC chip card 20 is intended to be installed indwelling within the object 12, the memory 28 furthermore stores one single ID. The memory 28 is, for example, a non-ephemeral memory, typically a flash memory.

The application 31 can, for example, be downloaded from a data communication network, not represented in the figures for reasons of clarity. The application 31 comprises program instruction adapted to use a portion of the method for establishing a connection between the object 12 and the first cellular communication network 14A, as described below. In a non-represented variant, the application 31 is not stored in the memory 28 of the UICC chip card 20, but in a memory of the object 12.

The list 32 of forbidden cellular communication networks for the connection comprises an ID of the first cellular communication network 14A. This means, in practice, that the object 12 has already attempted to connect to the first cellular communication network 14A while it was not authorized to do it. When the UICC chip card 20 is a SIM card, the list 32 is a standardized list, otherwise called FPLMN (Forbidden Public Land Mobile Network) list.

The list 33 of cellular communication networks to be favored comprises an ID of the second cellular communication network 14B. Indeed, the object 12 is effectively connected to the second cellular communication network 14B. When the UICC chip card 20 is a SIM card, the list 33 is a standardized list, otherwise called PLMNSel (Public Land Mobile Network Selected) list. In a non-represented variant, the memory 28 of the UICC chip card 20 does not store the list 33 of cellular communication networks to be favored, but a list of cellular communication networks equivalent to a domestic cellular communication network. The domestic cellular communication network can for example be the second cellular communication network 14B, but can also be another cellular communication network. According to this variant, the list of equivalent cellular communication networks comprises an ID of the second cellular communication network 14B. Furthermore, when the UICC chip card 20 is a SIM card, the list of equivalent cellular communication networks is a standardized list, otherwise called EHPLMN (Equivalent Home Public Land Mobile Network) list. Also in a variant, the memory 28 of the UICC chip card 20 stores the list 33 of cellular communication networks to be favored and the list of equivalent cellular communication networks, at least one of the two lists comprising an ID of the second cellular communication network 14B.

The communication means 24 over a cellular communication network 14A, 14B are for example formed of a transceiver. The transceiver 24 is, for example, a cellular modem.

The calculation means 26 are, for example, formed of a processor.

The calculation means 26, for example, form part of a firmware specifically configured to be able to interact with the UICC chip card 20, and in particular to be able to execute the application 31, as will be described below.

Each of the first and second communication systems 19A, 19B, comprises for example, a server 36A, 36B.

Each server 36A, 36B comprises storage means and data processing means connected to the storage means, these different means not being represented in the figures for reasons of clarity.

The HLR or HSS system 21 typically comprises a central database 38. The central database 38 is connected to the server 36A, 36B of each of the first and second communication systems 19A, 19B, as illustrated in FIG. 1. The central database 38 is typically a base for geographically localizing HLR-type subscribers, or also a core base of HSS-type network. The central database 38 is capable of being configured, for example remotely, to be able to authorize access of the UICC chip card 20 of the object 12 to the first cellular communication network 14A, or to the second cellular communication network 14B.

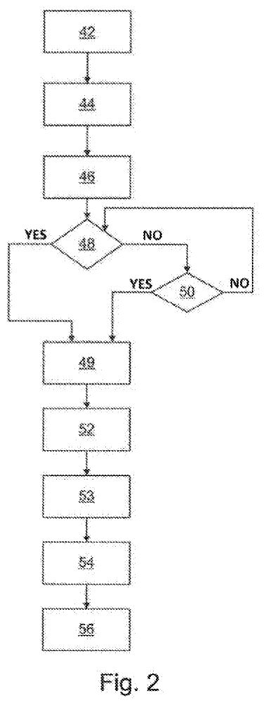

The functioning of the communication assembly 18 will now be described in detail, in reference to FIG. 2. In particular, the method for establishing a connection between the object 12 and the first cellular communication network 14A, used by the communication assembly 18, will be described in reference to FIG. 2.

Initially, it is assumed that the object 12 is connected to the second cellular communication network 14B. More specifically, the UICC chip card 20 is used to make it possible for an authentication of the object 12 containing the UICC chip card 20, to the second cellular communication network 14B. This means, in practice, that access to the second cellular communication network 14B is authorized for the UICC chip card 20 of the object 12, within the second communication system 19B. Furthermore, it is assumed that access to the first cellular communication network 14A is forbidden for the UICC chip card 20 of the object 12, within the first communication system 19A. This means, in practice, that within the UICC chip card 20, the list 32 of forbidden cellular communication networks for the connection comprises an ID of the first cellular communication network 14A.

More specifically, an HLR or HSS system 21, can authorize access to the UICC card 20 to the first cellular communication network 14A, and forbid access of this card to the second cellular communication network 14B.

This situation can result from two prior steps 42, 44 of using steps of the method according to embodiments of the invention:

During an initial step 42, an access to the first cellular communication network 14A is authorized for the UICC chip card 20 of the object 12, within the HLR or HSS system 21. More specifically, the central database 38 of the HLR or HSS system 21 is configured, for example remotely, so as to authorize access to the UICC chip card 20 of the object 12 to the first cellular communication network 14A. This modification of the central database 38 can, for example, correspond to a cellular network operator change for the object 12.

During a parallel or following step 44, an access to the second cellular communication network 14B is forbidden for the UICC chip card 20 of the object 12, within the HLR or HSS system 21. More specifically, the central database 38 of the HLR or HSS system 21 is configured, for example remotely, so as to forbid access of the UICC chip card 20 of the object 12 to the second cellular communication network 14B. This modification of the central database 38 can, for example, correspond to a cellular network operator change for the object 12.

In a variant, the authorization and forbidding 44 steps can be reversed.

During a following step 46, the object 12 transmits over the second cellular communication network 14B, via the communication means 24 thereof, a request to establish a connection to the second cellular communication network 14B. This request to establish a connection is transmitted to the server 36B of the second communication system 19B, which processes it in line with the central database 38. From this step 46, the object 12 receives a response from the server 36B of the second communication system 19B, indicating that access of the UICC chip card 20 of the object 12 to the second cellular communication network 14B is thus forbidden.

Preferably, according to an advantageous embodiment of the invention, the last cellular communication network to which the object 12 is successfully connected is stored within the UICC chip card 20, typically within the memory 28 of the chip card 20. According to this advantageous embodiment, the application 31 of the UICC chip card 20 is executed during a following step 48. The application 31 is, for example, executed by the microprocessor 30 of the UICC chip card 20. In a variant, the application 31 is executed by the means for calculation 26 the object 12. During this step 48, the application 31 tests if the last cellular communication network to which the object 12 is successfully connected is the second cellular communication network 14B. If so, the application 31 deletes, during a following step 49, the content of the list 32 of forbidden cellular communication networks for the connection.

Preferably, according to this advantageous embodiment, if the result of the test carried out in step 48 is that the last cellular communication network to which the object 12 is successfully connected is not the second cellular communication network 14B, but a third cellular communication network, thus the application 31 tests, during a following step 50, if the third cellular communication network is associated with the second network 14B via a preestablished roaming service. If so, the application 31 is executed and the deletion step 49 is used. If not, the test step 48 is used again.

Preferably, during a step 52 according to the deletion step 49, the calculation means 26 of the object 12 read, within the UICC chip card 20, the content of the list 32 of forbidden cellular communication networks for the connection, updated beforehand.

During a following step 53, the application 31 of the UICC chip card 20 is notified of a connection refusal by the second network. It can, for example, be notified of this by receiving a “limited service” event. This refusal can trigger the addition, by the application 31, of an ID of the second cellular communication network 14B within the list 32 of forbidden cellular communication networks for the connection.

In a variant, the reading 52 and addition 53 steps can be reversed.

Also in a variant, the deletion step 49 is no longer used following a triggering condition, as described in the two preceding cases, but is used periodically, without specific triggering condition. According to this embodiment variant, and when the memory 28 of the UICC chip card 20 stores a list 33 of cellular communication networks to be favored for the connection, and/or a list of cellular communication networks equivalent to a domestic cellular communication network, the method comprises a step during which the application 31 of the UICC chip card 20 deletes the ID of the second cellular communication network 14B within this or these list(s). This deletion step is, for example, used following the addition step 53. In a variant, this deletion step can be used between the transmission step 46 and the addition step 53. Preferably, the method then comprises a step during which the calculation means 26 of the object 12 read, within the UICC chip card 20, the content of the list 33 of cellular communication networks to be favored for the connection, and/or the list of cellular communication networks equivalent to a domestic cellular communication network, updated beforehand.

During a following step 54, the object 12 transmits over the first cellular communication network 14A, via the communication means 24 thereof, a request to establish a connection to the first cellular communication network 14A. This request to establish a connection is transmitted to the server 36A of the first communication system 19A, which processes it in line with the central database 38. From this step 54, the object 12 receives a response from the server 36A of the first communication system 19A, indicating that access of the UICC chip card 20 of the object 12 to the first cellular communication network 14A is-authorized.

Preferably, when the memory 28 of the UICC chip card 20 stores a list 33 of cellular communication networks to be favored for the connection, and/or a list of cellular communication networks equivalent to a domestic cellular communication network, the method comprises a following step, during which the application 31 of the UICC chip card 20 adds an ID of the first cellular communication network 14A within this or these list(s). Preferably, the method then comprises a step during which the calculation means 26 of the object 12 read, within the UICC chip card 20, the content of the list 33 of cellular communication networks to be favored for the connection, and/or the list of cellular communication networks equivalent to a domestic cellular communication network, updated beforehand.

During a following step 56, which is the final step, a connection is established between the object 12 and the first cellular communication network 14A. In particular, the object 12 is thus connected to the first communication system 19A.

The invention is described above as an example. It is understood that a person skilled in the art is able to produce different embodiment variants of the invention, by associating, for example, the different characteristics above taken individually or in combination, without moving away from the scope of the invention.

1. Method for establishing a connection between an object and a first cellular communication network, the object comprising a UICC chip card and means for communicating over a cellular communication network, connected to the UICC chip card, the object being connected to a second cellular communication network, the UICC chip card comprising a memory storing a list of forbidden cellular communication networks for the connection, said list comprising an ID of the first cellular communication network,
the method comprising the following steps:
a step of transmitting by the object over the second cellular communication network, of a request to establish a connection to the second cellular communication network; and
a step of notifying that communication was refused by said second cellular communication network;
wherein the method further comprises:
a step of deleting the content of the list of forbidden cellular communication networks;
a step of transmitting, by the object over the first cellular communication network, of a request to establish a connection to the first cellular communication network; and
a step of establishing the connection between the object and the first cellular communication network.

2. The method according to claim 1, wherein said notification step comprises the addition of an ID of the second cellular communication network within the list of forbidden cellular communication networks.

3. The method according to claim 2, wherein the last cellular communication network to which the object is successfully connected is stored within the UICC chip card.

4. The method according to claim 3, if the last cellular communication network to which the object is successfully connected is the second cellular communication network, the step of deleting content of the list of forbidden cellular communication networks is used after the step of transmitting a request to establish a connection to the second cellular communication network.

5. The method according to claim 4, wherein, if the last cellular communication network to which the object is successfully connected is not the second cellular communication network, but a third cellular communication network, the method further comprises a step aiming to test if the third cellular communication network is associated with the second cellular communication network via a preestablished roaming service, the step of deleting content of the list of forbidden cellular communication networks being used if the result of the test step is positive.

6. The method according to claim 4, that wherein the method further comprises a reading step, by the object, of the content of the list of forbidden cellular communication networks, said reading step being used after the deletion step.

7. The method according to claim 2 wherein the memory of the UICC chip card furthermore stores a list of cellular communication networks to be favored for the connection and/or a list of cellular communication networks equivalent to a domestic cellular communication network, at least one of said lists initially comprising an ID of the second cellular communication network; and wherein the method further comprises a step of deleting the ID of the second cellular communication network within said or one of said lists, and a step of adding an ID of the first cellular communication network within said or one of said lists.

8. The method according to claim 6, wherein the method further comprises a step of reading, by the object, content of the list of cellular communication networks to be favored and/or content of the list of cellular communication networks equivalent to a domestic cellular communication network.

9. A computer program product which can be downloaded from a communication network and/or recorded on a support which can be read by UICC chip card type computer and/or which can be executed by a processor, comprising program instructions, said program instructions being adapted to use at least the steps of notifying and deleting the method for establishing a connection according to claim 1 when the program product is executed on a processing unit of the object or on the UICC chip card.

10. A UICC chip card comprising a memory, characterised in that said memory stores a computer program product comprising program code instructions to use at least the notification and deletion steps of the method for establishing a connection according to claim 1.

11. The UICC chip card according to claim 9, wherein the UICC chip card is a SIM card.

12. The UICC chip card according to claim 10, wherein the UICC chip card is a SIM card intended to be installed indwelling in an object, the memory of said SIM card storing one single ID.
